(19) United States
(12) Patent Application Publication
(10) Pub. No.: US 2023/0313990 A1
(43) Pub. Date: Oct. 5, 2023

(54) SYSTEMS AND METHODS FOR A GAS TRAIN

(71) Applicant: Nala Robotics, Inc., Arlington Heights, IL (US)

(72) Inventors: Vijay Kodali, Palatine, IL (US); Ajay Kumar Sunkara, South Barrington, IL (US)

(21) Appl. No.: 17/708,113

(22) Filed: Mar. 30, 2022

(51) Int. Cl. F23N 5/20; F23N 5/02; A47J 36/32

(52) U.S. Cl. CPC F23N 5/203; F23N 5/022; F23N 5/206; A47J 36/32; F23N 2227/36; F23N 2235/16; F23N 2237/02; F23N 2241/08

(57) ABSTRACT

Systems and methods for a gas train assembly for an automated cooking system are provided. In one embodiment, the gas train assembly includes an electronic controller, a booster, a first burner assembly, and a first mass flow controller. The electronic controller is configured to identify a recipe associated with an order for a food item. The booster is configured to increase the pressure of the gas to a high-pressure value. The first burner assembly is downstream from the booster. The first mass flow controller is interposed between the booster and the first burner assembly. The first mass flow controller receives a first burner setting from the electronic controller. The first burner setting is based on the recipe. The first mass flow controller allows gas to flow through the first mass flow controller and toward the first burner assembly at a first pressure value corresponding to the first burner setting.

### BACKGROUND

Natural gas for residential and commercial use is transported through long pipelines that connect the utility to users at residential and commercial locations. The gas is processed through many steps before being moved to residential and commercial locations at a lower pressure level. For example, natural gas may be delivered to commercial locations at 1-2 pounds per square inch (psi) and to residential locations at less than 1 psi.

### BRIEF DESCRIPTION

In one embodiment, a gas train assembly includes an electronic controller, a booster, a first burner assembly, and a first mass flow controller. The electronic controller is configured to identify a recipe associated with an order for a food item. The booster is configured to receive a gas at a pressure having a low-pressure value and increase the pressure of the gas to a high-pressure value. The first burner assembly is downstream from and in fluid communication with the booster. The first mass flow controller is in computer communication with the electronic controller and interposed between and in fluid communication with the booster and the first burner assembly. The first mass flow controller configured to receive a first burner setting from the electronic controller. The first burner setting is based on the recipe. The first mass flow controller is further configured to allow gas to flow through the first mass flow controller and toward the first burner assembly at a first pressure value corresponding to the first burner setting.

In another embodiment, a computer-implemented method for a gas train assembly of an automated cooking system. The computer-implemented method includes receiving a gas at a low-pressure value from a gas source. The computer-implemented method also includes increasing the pressure of the gas to a high-pressure value. The computer-implemented method further includes identifying, at an electronic controller, a first recipe associated with an order for a food item. The computer-implemented method yet further includes receiving a first burner setting at a first mass flow controller from the electronic controller. The first burner setting is based on the first recipe. The computer-implemented method includes allowing gas to flow to a first burner assembly at a first pressure value corresponding to the first burner setting.

### BRIEF DESCRIPTION OF THE DRAWINGS

FIG. 1 is a schematic view of the gas train system, according to one embodiment.

FIG. 2 is an exploded perspective view of a first branch of the gas train system, according to one embodiment.

FIG. 3 is a perspective view of an igniter with a portion broken away, according to one embodiment.

FIG. 4 is an exploded perspective view of a trunk line of the gas train system, according to one embodiment.

FIG. 5 is a flow diagram for utilizing a gas train system, according to one embodiment.

FIG. 6 is another flow diagram for utilizing a gas train system, according to one embodiment.

### DETAILED DESCRIPTION

A fully automated kitchen that uses gas stoves may receive gas, such as a natural gas, from a gas source. The gas source may be a utility line, for example supplying natural gas to a residential or commercial location. However, as discussed above, natural gas may be delivered to commercial locations at a pressure value of 1-2 psi and to residential locations at a pressure value of less than 1 psi. These pressure values may not be sufficient to ignite the burner, change the flame intensity, turn-off the burner, etc. Furthermore, even if the gas is supplied at a sufficient pressure value, the pressure value may not correspond to the pressure needed to prepare food in the automated kitchen.

The systems and methods for the gas train assembly described herein electronically and dynamically control gas flow to a burner of an automated kitchen to cook a food item without human intervention. When an order is received at an electronic controller, the electronic controller identifies a recipe associated with the food item. The recipe includes burner setting for one or more burners of one or more gas kitchen appliances. The electronic controller controls a mass flow controller, in fluid communication with a burner, to control the heat level at the burner. The electronic controller may further control ignition at the burner as well as shut off. In this manner the burner may be controlled without human intervention.

The gas train assembly may further include a booster and a plurality of gas regulators. The booster increases the pressure of the gas for cooking. For example, the gas may be natural gas that may have inadequate pressure for cooking. By using the booster and a plurality of gas regulators in series, the gas pressure may provided at pressure adequate for cooking as controlled by the mass flow controller. Accordingly, the gas train assembly may be utilized by an automated cooking system to cook the food item without human intervention.

### Definitions

The following includes definitions of selected terms employed herein. The definitions include various examples and/or forms of components that fall within the scope of a term and that can be used for implementation. The examples are not intended to be limiting. Further, the components discussed herein, can be combined, omitted or organized with other components or into different architectures.

“Bus,” as used herein, refers to an interconnected architecture that is operably connected to other computer components inside a computer or between computers. The bus can transfer data between the computer components. The bus can be a memory bus, a memory processor, a peripheral bus, an external bus, a crossbar switch, and/or a local bus, among others.

“Computer communication,” as used herein, refers to a communication between two or more computing devices (e.g., computer, personal digital assistant, cellular telephone, network device) and can be, for example, a network transfer, a data transfer, a file transfer, an applet transfer, an email, a hypertext transfer protocol (HTTP) transfer, and so on. A computer communication can occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, among others. Computer communication can utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Data store,” as used herein can be, for example, a magnetic disk drive, a solid-state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

“Input/output device” (I/O device) as used herein can include devices for receiving input and/or devices for outputting data. The input and/or output can be for controlling different features which include various components, systems, and subsystems. Specifically, the term “input device” includes, but it not limited to: keyboard, microphones, pointing and selection devices, cameras, imaging devices, video cards, displays, push buttons, rotary knobs, and the like. The term “input device” additionally includes graphical input controls that take place within a user interface which can be displayed by various types of mechanisms such as software and hardware-based controls, interfaces, touch screens, touch pads or plug and play devices. An “output device” includes, but is not limited to: display devices, and other devices for outputting information and functions.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry can include and/or be a part of a processor controlled by an algorithm, a discrete logic (e.g., ASIC), an analog circuit, a digital circuit, a programmed logic device, a memory device containing instructions, and so on. Logic can include one or more gates, combinations of gates, or other circuit components. Where multiple logics are described, it can be possible to incorporate the multiple logics into one physical logic. Similarly, where a single logic is described, it can be possible to distribute that single logic between multiple physical logics.

“Memory,” as used herein can include volatile memory and/or nonvolatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory can store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module can also include logic, a software-controlled microprocessor, a discrete logic circuit, an analog circuit, a digital circuit, a programmed logic device, a memory device containing executing instructions, logic gates, a combination of gates, and/or other circuit components. Multiple modules can be combined into one module and single modules can be distributed among multiple modules.

“Processor,” as used herein, processes signals and performs general computing and arithmetic functions. Signals processed by the processor can include digital signals, data signals, computer instructions, processor instructions, messages, a bit, a bit stream, that can be received, transmitted and/or detected. Generally, the processor can be a variety of various processors including multiple single and multicore processors and co-processors and other multiple single and multicore processor and co-processor architectures. The processor can include logic circuitry, such as a programmable logic controller, to execute actions and/or algorithms.

### I. System Overview

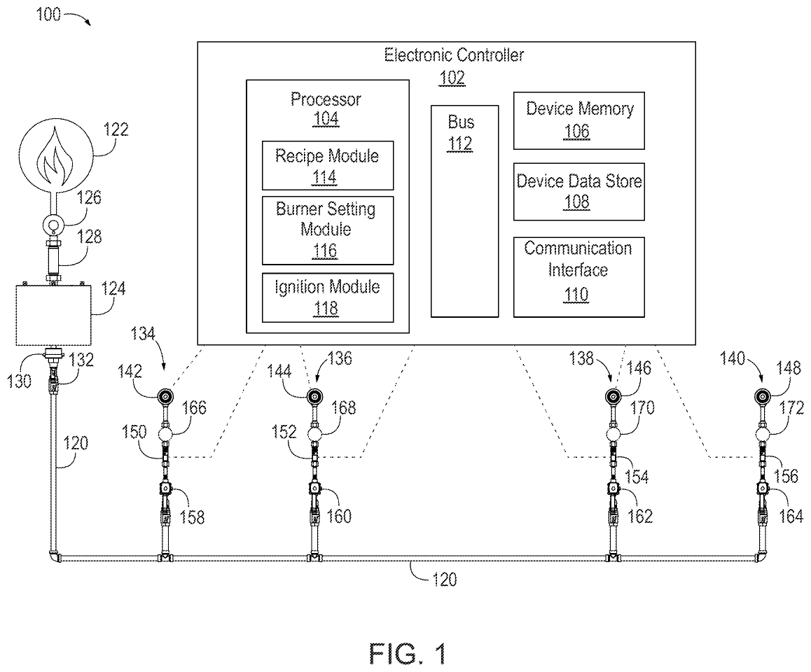

Referring now to the drawings, wherein the showings are for purposes of illustrating one or more exemplary embodiments and not for purposes of limiting same, FIG. 1 is a schematic diagram of a gas train assembly 100 for use, in whole or in part, in an automated kitchen. The automated kitchen may use gas kitchen appliances such as ranges, stove tops, deep fryers, etc. (not shown).

The gas train assembly 100 includes an electronic controller 102 that communicates with other components of the gas train assembly 100 via a network that may be wired or wireless to allow components the gas train assembly 100 engage in computer communication. The electronic controller 102 of the gas train assembly 100, as well as the components of other systems, hardware architectures, and software architectures discussed herein, may be combined, omitted, or organized into different architectures for various embodiments.

Generally, the electronic controller 102 includes a processor 104, a device memory 106, a device data store 108, and a communication interface 110, which are each operably connected for computer communication via a bus 112 and/or other wired and wireless technologies. The electronic controller 102, can include provisions for processing, communicating, and interacting with various components of the gas train assembly 100. In one embodiment, the electronic controller 102 can be implemented with the gas train assembly 100, for example, as part of a telematics unit, a head unit, an electronic control unit, an on-board unit, or as part of a specific robotic system, among others. In other embodiments, the electronic controller 102 can be implemented remotely and be connected via the network.

The processor 104 can include logic circuitry with hardware, firmware, and software architectural frameworks for automated cooking. Thus, in some embodiments, the processor 104 can store application frameworks, kernels, libraries, drivers, application program interfaces, among others, to execute and control hardware and functions discussed herein. For example, the processor 104 can include a recipe module 114, a burner setting module 116, and an ignition module 118, although it is understood that the processor 104 can be configured into other architectures. Further, in some embodiments, the device memory 106 and/or the device data store 108 can store similar components as in the processor 104 for execution by the processor 104.

The gas train assembly 100 further includes a trunk line 120 that receives a gas from the gas source 122. The gas source 122 may be a pipeline used to transport a gas, such as natural gas, from a utility. Alternatively, the gas source 122 may be a storage container storing gas. The gas source 122 provides gas to the trunk line 120 at a low-pressure value. For example, the gas source 122 may provide the gas to the trunk line 120 at a low-pressure value under 2 psi. The gas source 122 may also provide the gas at variable pressures based on environmental characteristics (e.g., distance to the gas source 122, weather conditions, gas production, etc.). Accordingly, the low-pressure value may also be variable.

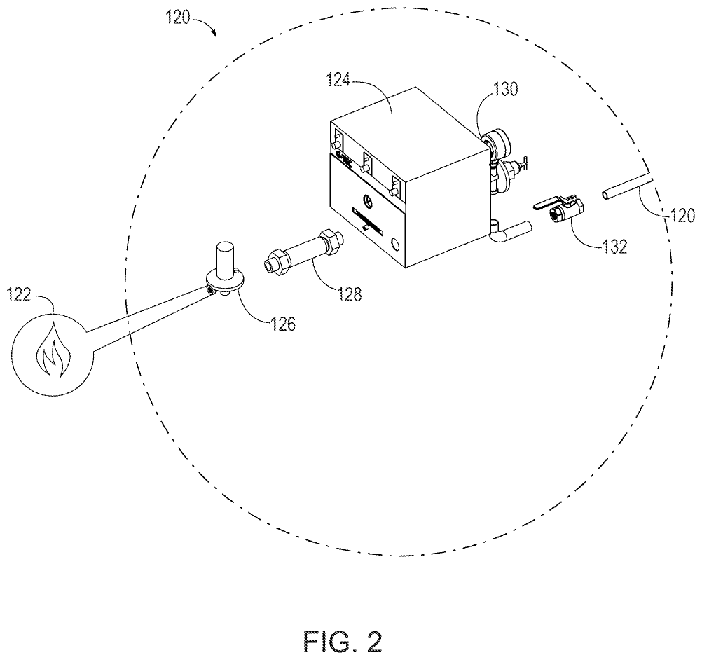

The trunk line 120 includes a booster 124, shown in greater detail in FIG. 2, that increases the pressure of the gas from the low-pressure value to a high-pressure value. The booster 124 may include a large diameter air driven piston that is connected to a smaller diameter gas boost piston. The gas, having the low-pressure value, acting on the drive piston, generates force to the boost piston which increases the pressure of the gas in a boost cylinder to the high-pressure value.

In another embodiment, the trunk line 120 may include a trunk line pressure regulator 126 to avoid variability in the low-pressure value. The trunk line pressure regulator 126 regulates the pressure of the gas to a constant low-pressure value before the gas enters the booster 124. The trunk line pressure regulator 126 is disposed upstream of, and in fluid communication with, the booster 124. The trunk line pressure regulator 126 may include a spring valve that applies pressure against an opposing pressure in the trunk line 120, enabling the spring valve to open enough to pressurize the downstream side according to a predetermined pressure value. For example, the predetermined pressure value may be 2 psi. In such an embodiment, the gas source 122 provides a gas at a low-pressure value in the low-pressure window to the trunk line pressure regulator 126. The trunk line pressure regulator 126 then outputs the gas at the predetermined pressure value. The booster 124 receives the gas at the predetermined pressure value and outputs the gas at the high-pressure value.

The trunk line 120 may further include a gas filter 128 interposed between and in fluid communication with the booster 124 and the trunk line pressure regulator 126. The gas filter 128 may be an inline filter that captures particles (e.g., dust, lint, fibers, animal fur, etc.) from the gas of the gas source 122 before the gas flows to the booster 124.

The booster 124 may include a booster regulator gauge 130. The booster regulator gauge 130 is configured to set the high-pressure value. The booster regulator gauge 130 may be a single stage regulator. The booster regulator gauge 130 may include an analog or digital gauge that the displays the high-pressure value. The booster 124 may further include a booster shut off valve 132 to shut off flow of the gas downstream from the booster 124, such that the gas having the high-pressure value is unable to flow from the booster 124 into sections of the trunk line 120 downstream from the shut off valve 132.

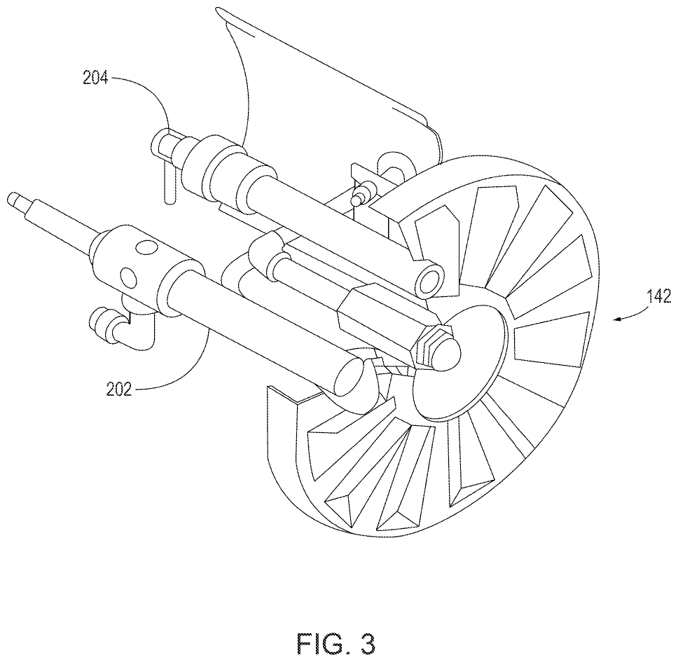

The trunk line 120 feeds one or more parallel branches, such as the first branch 134, the second branch 136, the third branch 138, and the fourth branch 140. The branches 134-140 terminate at corresponding burner assemblies, such as the first burner assembly 142, the second burner assembly 144, the third burner assembly 146, and the fourth burner assembly 148. The burner assemblies 142-148 each include an igniter and a flame sensor. For example, turning to FIG. 3, the first burner assembly 142 may include a first igniter 202 and a first flame sensor assembly 204. The second burner assembly 144, the third burner assembly 146, and the fourth burner assembly 148 may be similarly configured, but only the first burner assembly 142 will be described with particularity for the sake of brevity.

The first igniter 202 is configured to ignite the gas flowing to the first burner assembly 142 from the trunk line 120. In one embodiment, the first igniter 202 may be configured to draw current at the first burner assembly 142. The first igniter 202 may be a glow bar which heats and draws electrical current. As the gas flows past the first igniter 202, the gas is ignited at the first burner assembly 142. Alternatively, the first igniter 202 may include an igniter rod and a hammer. When the hammer strikes the igniter rod, a spark is generated at the first burner assembly 142. In some embodiments, the first igniter 202 may be configured to generate a series of sparks in response to receiving a spark signal from the ignition module 118 via the network.

The first igniter 202 may be activated to draw current or generate one or more sparks until a flame is detected at the first burner assembly 142. The first flame sensor assembly 204 sends a first flame detection signal when a flame is detected at the first burner assembly 142. For example, the first flame sensor assembly 204 may be a detection rod that generates a current when exposed to a flame. The current of the first flame sensor assembly 204 may be used to generate the first flame detection signal. The first flame detection signal may be received by the electronic controller 102, specifically by the ignition module 118, so that the ignition module 118 can control the first igniter 202 and the first flame sensor assembly 204.

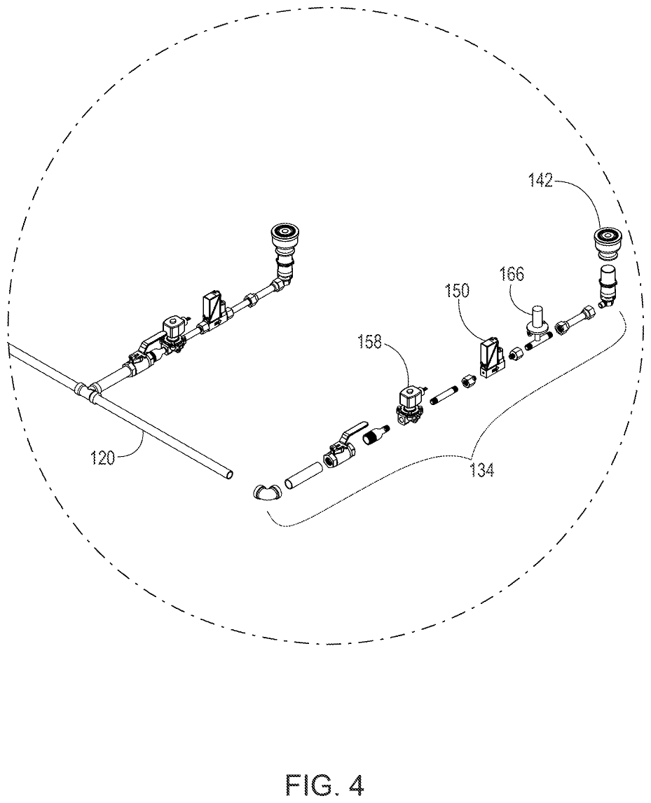

The branches also include mass flow controllers that are coupled to the electronic controller 102 for computer communication, shown in greater detail in FIG. 4. For example, the first branch 134 includes a first mass flow controller (MFC) 150, the second branch 136 includes a second MFC 152, the third branch 138 includes a third MFC 154, the fourth branch 140 includes a fourth MFC 156.

The first MFC 150 is interposed and is in fluid communication with the booster 124 and the first burner assembly 142. The first MFC 150 is configured to measure and control the flow of gas to the first burner assembly 142. In particular, the first MFC 150 is configured to receive, via the network, a first burner setting from the electronic controller 102. The first MFC 150 is further configured to allow the gas to flow to the first burner assembly 142 at a first pressure value corresponding to the first burner setting. Likewise, the second burner assembly 144, downstream from and in fluid communication with the booster 124, includes the second MFC 152. The second MFC 152 may receive a second burner setting from the electronic controller 102. The second MFC 152 allows the gas to flow through the second MFC 152 and toward the second burner assembly 144 at a second pressure value corresponding to second burner setting. The third MFC 154 and the fourth MFC 156 operate in a similar manner as the first MFC 150 and the second MFC 152 for the third branch 138 and the fourth branch 140, respectively.

In some embodiments, the electronic controller 102 may set an MFC to have a default burner setting. The default burner setting may be associated with a default pressure value that is less than the high-pressure value but greater than the low-pressure value. The default pressure value may also be lower than a first pressure value or second pressure value associated with a recipe. For example, the default pressure value may keep a burner at a low temperature, such as warm, so that the burner does not have to be heated from cold or lit when a new food item is ordered.

In another embodiment, the MFCs 150-156 may allow the gas to flow to the respective burner assemblies 142-148 for a predetermined amount of time. For example, the first MFC 150 may allow gas to flow toward the first burner assembly 142 for a first flow time. The flow of the gas may then be modified by the first MFC 150 at the first pressure value, based on the recipe, in response to the first flow time elapsing. In this manner, the electronic controller 102 may control the MFCs, such as the first MFC 150, based on preparation time in the recipe. For example, if it will take the automated kitchen a predetermined prep time to retrieve and/or prepare (e.g., slice, dice, marinade, etc.) a raw food item, the electronic controller 102 may set the first flow time to the predetermined prep time.

The branches also include a number of shut-off valves that are coupled to the electronic controller 102 via the network for computer communication. For example, the first branch 134 includes a first shut-off valve 158, the second branch 136 includes a second shut-off valve 160, the third branch 138 includes a third shut-off valve 162, and the fourth branch 140 includes a fourth shut-off valve 164. The shut-off valves 158-164 operate to selectively regulate flow in the corresponding branch based on the condition of the shut-off valve. For example, the first shut-off valve 158 may have an open condition, a closed condition, and one or more partial conditions. In the open position, the first shut-off valve 158 may allow full flow of gas in the first branch 134. In the closed condition, the first shut-off valve 158 may prevent the flow of gas in the first branch 134. In the one or more partial conditions, the first shut-off valve 158 may regulate flow to one or more predetermined levels. The second shut-off valve 160, the third shut-off valve 162, and the fourth shut-off valve 164 may be similarly configured to operate with multiple conditions, but only the first shut-off valve 158 will be described with particularity for the sake of brevity.

The first shut-off valve 158 is in fluid communication with the booster 124 and the first burner assembly 142. The first shut-off valve 158 is interposed between the booster 124 and the first MFC 150. The first shut-off valve 158 is configured to shut-off the flow of gas in the first branch 134 downstream from the first shut-off valve 158 in response to a shut-off signal from the electronic controller 102. Likewise, the second shut-off valve 160 is interposed between the booster 124 and the second MFC 152 and is configured to shut-off the flow of gas in the second branch 136 downstream from the second shut-off valve 160 in response to the shut-off signal from the electronic controller 102. The third shut-off valve 162 and the fourth shut-off valve 164 are likewise configured to shut-off the flow of the gas in the third branch 138 and the fourth branch 140 respectively.

In some embodiments, the ignition module 118 may determine that the first flame detection signal has not been received in a predetermined amount of time since receiving the first spark signal. In response to the predetermined amount of time elapsing, the ignition module 118 may cause the first shut-off valve 158 to shut off flow of gas to the first burner assembly 142.

The branches also include a number of branch pressure regulators that are coupled to the electronic controller 102 for computer communication. For example, the first branch 134 includes a first branch pressure regulator 166, the second branch 136 includes a second branch pressure regulator 168, the third branch 138 includes a third branch pressure regulator 170, and the fourth branch 140 includes a fourth branch pressure regulator 172.

The first branch pressure regulator 166 is in fluid communication with the booster 124 and the first burner assembly 142. The first branch pressure regulator 166 is interposed between the first MFC 150 and the first burner assembly 142. The first branch pressure regulator 166 is configured to reduce the flow of gas toward the first burner assembly 142 to a limited pressure value. The limited pressure value may be set based on safety considerations. In this manner the first branch pressure regulator 158 may limit the pressure to a safe limit in the event that the first MFC 150 and/or the first shut-off valve 158 fail. Likewise, the second branch pressure regulator 168 is interposed between the second MFC 152 and the second burner assembly 144. The second branch pressure regulator 168 is configured to limit the flow of gas toward the second burner assembly 144 to the limited pressure value. The third branch pressure regulator 170 and the fourth branch pressure regulator 172 may be similarly configured, but only the first branch pressure regulator 166 and the second branch pressure regulator 168 will be described with particularity for the sake of brevity.

In some embodiments, the limited pressure value may be different for each branch. For example, the first branch pressure regulator 166 may limit the pressure of the gas to the first limited pressure value and the second branch pressure regulator 168 may limit the pressure of the gas to a second limited pressure value. The limited pressure value may be based on the application of the respective burner assembly of the respective branch. For example, the first burner assembly 142 may be for a range while the second burner assembly 144 may be for a deep fryer. For safety considerations, the second burner assembly 144 may have a lower limited pressure value than the first burner assembly 142. Accordingly, the branch pressure regulators may have different limited pressure values. The third branch pressure regulator 170 and the fourth branch pressure regulator 172 are likewise configured to limit the flow of gas through the third branch 138 and the fourth branch 140, respectively, at limited pressure values. Detailed embodiments describing exemplary methods using the system and network configuration discussed above will now be discussed in detail.

### II. METHODS

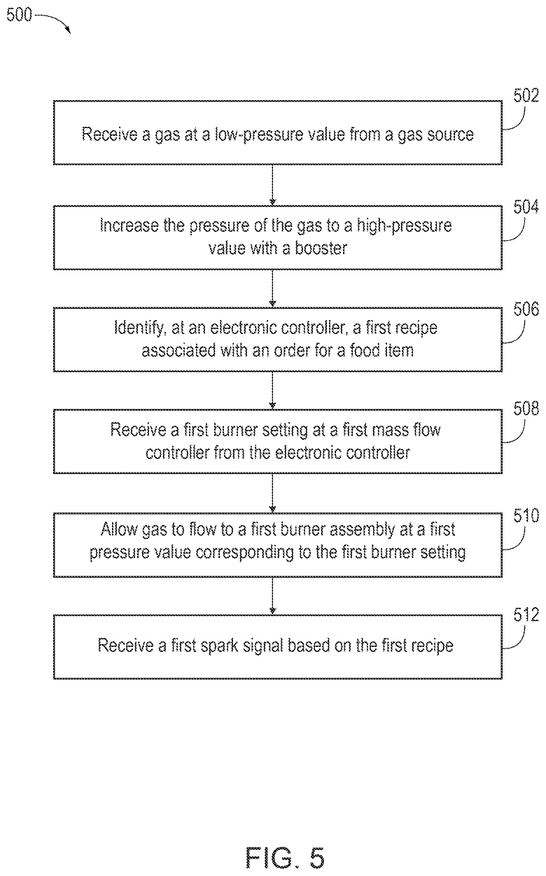

Referring now to FIG. 5, a computer-implemented method 500 for a gas train assembly 100 will be described according to an exemplary embodiment. FIG. 5 will also be described with reference to FIGS. 1-4. For simplicity, the method 500 will be described by the following steps, but it is understood that the elements of the method 500 can be organized into different architectures, blocks, stages, and/or processes.

At block 502, the method 500 includes receiving a gas at a low-pressure value from a gas source 122. The gas may be a hydrocarbon-based gas used for cooking. In one embodiment, the gas may be natural gas. The gas source 122 may be a storage reservoir or utility delivering gas via infrastructure.

At block 504, the method 500 includes increasing the pressure of the gas to a high-pressure value with a booster 124. For example, suppose that the gas source 122 provides the gas at the low-pressure value, such as 0.25 psi. The booster 124 may increase the pressure of the gas to the high-pressure value, such as 25 psi. As discussed above, the booster 124 may receive the gas at a variable pressure in a low-pressure window. For example, the low-pressure window may include gas having low-pressure values from 0.25 psi to 5.0 psi. The booster 124 may increase the pressure of the gas to the high-pressure value. The high-pressure value may be a value in a high-pressure window from any low-pressure value in the low-pressure window. The high-pressure window may include the gas being boosted to high-pressure values from 20.0 psi to 50.0 psi.

At block 506, the method 500 includes the recipe module 114 identifying a first recipe associated with an order for a food item. The first recipe may be stored locally on the electronic controller 102. For example, the recipes may be stored in the device memory 106 or the device data store 108. Further, the processor 104 may support an operating platform that incorporates edge computing to execute locally stored recipes.

A recipe, such as the first recipe, includes a set of instructions for preparing the at least one food item. For example, the recipe may include an exemplary set of instructions for a recipe for automated cooking, according to one aspect. The set of instructions includes a number of steps, such as a first step, a second step, a third step, a fourth step, etc. The steps may include actions that are operations to be taken by a robotic kitchen, including the gas train, to facilitate preparation of a food item, for example, stove ignition, preheating, flame control, ingredient identification, ingredient collection instructions, utensil selection, and cooking manipulations (e.g., mix, fold, pour, flip, etc.), among others. The operations may be associated with a number cooking parameters such as burner settings and/or corresponding pressure values, preheating time, cooking time, spark signals, etc. The steps may further include location of objects such as ingredients, containers, cookware, utensils, etc. Additionally, the set of instructions may also include locations, such as the first burner assembly 142, the second burner assembly 144, the third burner assembly 146, and/or the fourth burner assembly 148.

At block 508, the method 500 includes receiving a first burner setting at a first MFC 150 from the electronic controller 102. In particular, the first burner setting may be received at the first MFC 150 from the burner setting module 116 of the electronic controller 102.

The first burner setting is based on the first recipe. The first burner setting may be included in the recipe. The first burner setting may be a temperature value that indicates a temperature as a value in degrees. The temperature value may include a range of temperature values. The first burner setting may alternatively be a relative heat value including predetermined ranges, such as low, medium, and high.

In another embodiment, the first burner setting may be calculated based on the cooking parameters of the operations or locations included in the recipes. For example, if the first burner assembly 142 has a default burner setting of a low heat value, the second burner 144 has a default burner setting of a high heat value, and the recipe indicates that the location for the first recipe is the first burner assembly 142, then the first burner setting may be the default burner setting of the low heat value.

At block 510, the method 500 includes the first MFC 150 allowing gas to flow to a first burner assembly 142 at a first pressure value corresponding to the first burner setting.

The first MFC 150 may calculate the first pressure value based on the first burner setting. In one embodiment, the first pressure value may be determined from a look-up table stored locally on the electronic controller 102, the device memory 106, or the device data store 108, or the look-up table may be stored remotely. The first pressure value may additionally be based on other cooking parameters.

Because the first pressure value is based on the first burner setting, the first pressure value may be proportional to the first burner setting. For example, if the first burner setting indicates a high temperature value, then the first pressure value is also high. The medium burner setting may correspond to the medium pressure value, such that the first pressure value is less than the high-pressure value and greater than the low-pressure value.

At block 512, the method 500 includes the electronic controller 102 receiving a first spark signal based on the first recipe. The first spark signal causes a first igniter to generate a series of sparks at the first burner assembly 142. The series of sparks includes one or more sparks. Once the first burner assembly 142 is ignited, a first flame detection signal is received in response to a first flame being detected at the first burner assembly. The first flame detection signal causes the first igniter to stop generating the series of sparks in response to the first flame detection signal.

While described with respect to one burner for clarity, the systems and methods described herein may be used to ignite multiple burners. For example, the first recipe may include cooking two food items, such as a protein and a vegetable, that cook on different burners with different burner settings, such as a first burner setting and a second burner setting. Additionally or alternatively, an order for one or more food items may include multiple recipes, such as the first recipe and a second recipe. In this example, the first recipe may include a first burner setting and the second recipe may include a second burner setting.

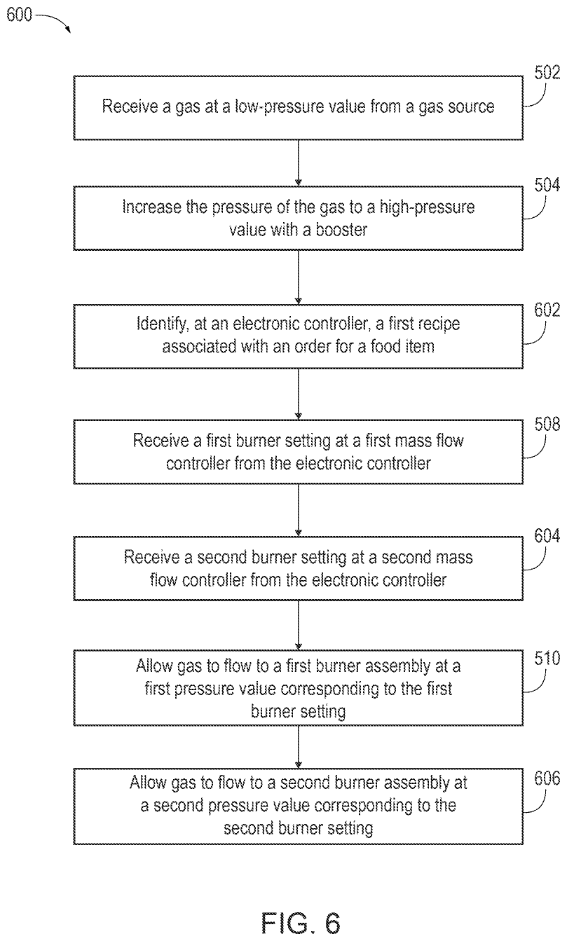

Referring now to FIG. 6, a computer-implemented method 600 for a gas train assembly 100 will be described according to an exemplary embodiment. FIG. 6 will also be described with reference to FIG. 1-5. For simplicity, the method 600 will be described by the following steps, but it is understood that the elements of the method 600 can be organized into different architectures, blocks, stages, and/or processes.

At block 502, the method 600 includes receiving a gas at a low-pressure value from a gas source 122, as described above with respect to the method 500.

At block 504, the method 600 includes increasing the pressure of the gas to a high-pressure value with a booster 124.

At block 602, the method 600 includes the recipe module 114 identifying a first recipe associated with an order and a second recipe associated with the order. The second recipe is identified in a similar manner as the first recipe, as discussed above with respect to block 506 of the method 500.

At block 508, the method 600 includes receiving a first burner setting at a first MFC 150 from the electronic controller 102.

At block 604, the method 600 includes receiving a second burner setting at a second MFC 152 from the electronic controller 102. The second burner setting is received in a similar manner as the first burner setting.

At block 510, the method 600 includes the first MFC 150 allowing gas to flow to a first burner assembly 142 at a first pressure value corresponding to the first burner setting.

At block 606, the method 600 includes the second MFC 152 allowing gas to flow to a second burner assembly 144 at a second pressure value corresponding to the second burner setting. The second MFC 152 operates in a similar manner as described above with respect to the first pressure value described above with respect to block 510. The first pressure value may different than the second pressure value. Accordingly, the first burner assembly 142 may be heated to a different heat level than the second burner assembly 144.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that several of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A gas train assembly for an automated cooking system, the gas train assembly comprising:
an electronic controller configured to identify a recipe associated with an order for a food item;
a booster configured to receive a gas, from a gas source, at a pressure having a low-pressure value and increase the pressure of the gas to a high-pressure value; and
a first burner assembly downstream from and in fluid communication with the booster; and
a first mass flow controller in computer communication with the electronic controller and interposed between and in fluid communication with the booster and the first burner assembly, the first mass flow controller configured to:
receive a first burner setting from the electronic controller, wherein the first burner setting is based on the recipe, and
allow gas to flow through the first mass flow controller and toward the first burner assembly at a first pressure value corresponding to the first burner setting.

2. The gas train assembly of claim 1, further comprising:
a second burner assembly downstream from and in fluid communication with the booster; and
a second mass flow controller in computer communication with the electronic controller and interposed between and in fluid communication with the booster and the second burner assembly, the second mass flow controller configured to:
receive a second burner setting from the electronic controller, wherein the second burner setting is based on the recipe, and
allow the gas to flow through the second mass flow controller and toward the second burner assembly at a second pressure value corresponding to second burner setting.

3. The gas train assembly of claim 2, wherein the first pressure value is different than the second pressure value.

4. The gas train assembly of claim 1, further comprising:
a trunk line pressure regulator interposed between the gas source and the booster and in fluid communication with the booster; and
a first branch pressure regulator interposed between the first mass flow controller and the first burner assembly and in fluid communication with the first burner assembly.

5. The gas train assembly of claim 4, wherein the first branch pressure regulator is configured to reduce the pressure of the gas from the high-pressure value to a limited pressure value.

6. The gas train assembly of claim 1, wherein the first mass flow controller is further configured to:
receive a default burner setting from the electronic controller, wherein the default burner setting is associated with a default pressure value that is less than the first pressure value and greater than the low-pressure value; and
allow the gas to flow to the first burner assembly at the default pressure value, in response to receiving the default burner setting.

7. The gas train assembly of claim 6, wherein the first mass flow controller is configured to:
allow the gas to flow to the first burner assembly at the default pressure value for a first flow time; and
increase the flow of the gas to the first burner assembly to the first pressure value in response to the first flow time elapsing.

8. The gas train assembly of claim 1, wherein the first burner assembly includes:
a first igniter downstream from the first mass flow controller, wherein the electronic controller further comprises an ignition module configured to:
receive a first spark signal based on the recipe; and
cause the first igniter to generate a series of sparks at the first burner assembly, wherein the series of sparks includes one or more sparks.

9. The gas train assembly of claim 8, further comprising:
a first flame sensor assembly at the first burner assembly, wherein the first flame sensor assembly is configured to detect a flame at the first burner assembly, and wherein the ignition module is further configured to:
receive a first flame detection signal from the first flame sensor assembly when the flame is detected at the first burner assembly; and
cause the first igniter to stop generating the series of sparks in response to the first flame detection signal.

10. The gas train assembly of claim 9, further comprising:
a first shut off valve interposed between the first mass flow controller and the first burner assembly and configured to selectively stop flow of the gas to the first burner assembly, wherein the ignition module is further configured to:
determine the first flame detection signal has not been received in a predetermined amount of time since receiving the first spark signal; and
cause the first shut-off valve to shut off flow of gas to the first burner assembly.

11. A computer-implemented method for a gas train assembly of an automated cooking system, the method comprising:
receiving a gas at a low-pressure value from a gas source;
increasing pressure of the gas from the low-pressure value to a high-pressure value with a booster;
identifying, at an electronic controller, a first recipe associated with an order for a food item;
receiving a first burner setting at a first mass flow controller from the electronic controller, wherein the first burner setting is based on the first recipe; and
allowing gas to flow to a first burner assembly at a first pressure value corresponding to the first burner setting.

12. The computer-implemented method of claim 11, further comprising:
receiving a second burner setting at a second mass flow controller from the electronic controller; and
allowing gas to flow through the second mass flow controller and toward a second burner assembly at a second pressure value corresponding to second burner setting.

13. The computer-implemented method of claim 12, wherein the second burner setting is based on the first recipe.

14. The computer-implemented method of claim 12, wherein the second burner setting is based on a second recipe.

15. The computer-implemented method of claim 12, wherein the first pressure value is different than the second pressure value.

16. The computer-implemented method of claim 15, wherein the first pressure value is less than the high-pressure value and greater than the low-pressure value.

17. The computer-implemented method of claim 11, wherein
receiving the gas at the booster from a trunk line pressure regulator upstream of the booster; and
reducing the flow of the gas, with a branch pressure regulator downstream of the booster, to a limited pressure value, wherein the limited pressure value is less than the high-pressure value and greater than the low-pressure value.

18. The computer-implemented method of claim 11, further comprising:
receiving a default burner setting at the first mass flow controller, wherein the default burner setting is associated with a default pressure value that is less than the first pressure value and greater than the low-pressure value; and
allowing the gas to flow to the first burner assembly at the default pressure value until the first burner setting is received at the first mass flow controller.

19. The computer-implemented method of claim 18, further comprising:
allowing the gas to flow to the first burner assembly at the default pressure value for a first flow time; and
increasing the flow of the gas to the first burner assembly at the first pressure value in response to the first flow time elapsing.

20. The computer-implemented method of claim 11, further comprising:
receiving a first spark signal, at the electronic controller, based on the first recipe;
causing a first igniter to generate a series of sparks at the first burner assembly, wherein the series of sparks includes one or more sparks;
receiving a first flame detection signal when a first flame is detected at the first burner assembly; and
causing the first igniter to stop generating the series of sparks in response to the first flame detection signal.
